(19) United States
(12) Patent Application Publication
(10) Pub. No.: US 2024/0010031 A1
(43) Pub. Date: Jan. 11, 2024

(54) PNEUMATIC TIRE

(71) Applicant: TOYO TIRE CORPORATION, Hyogo (JP)

(72) Inventor: Naoya KUBO, Hyogo (JP)

(21) Appl. No.: 18/347,080

(22) Filed: Jul. 5, 2023

(30) Foreign Application Priority Data
Jul. 7, 2022 (JP) 2022-109486

(51) Int. Cl. B60C 11/03

(52) U.S. Cl. CPC B60C 11/0304; B60C 2011/0369

(57) ABSTRACT

A pneumatic tire that is an example of an embodiment is a tire having a specified mounting direction with respect to a vehicle. A tread has: a main groove that extends in a circumferential direction and is located on a vehicle outer side when the pneumatic tire is mounted on the vehicle; and a shoulder block defined by the main groove and disposed on the vehicle outer side. The shoulder block is formed with lateral grooves connecting to the main groove. Each lateral groove inside is formed with a protrusion that is a raised groove bottom in a region adjacent to the main groove, and edges of the lateral groove are formed with incisions along a length direction of the lateral groove.

### CROSS REFERENCE TO RELATED APPLICATION

The entire disclosure of Japanese Patent Application No. 2022-109486 filed on Jul. 7, 2022 including the specification, claims, drawings, and abstract is incorporated herein by reference in its entirety.

### TECHNICAL FIELD

The present disclosure generally relates to a pneumatic tire, and more particularly to a tire having a specified mounting direction with respect to a vehicle.

### BACKGROUND

Conventionally, pneumatic tires have been widely known, each of which includes a tread having a plurality of main grooves extending in the tire circumferential direction and lateral grooves extending in a direction crossing the main grooves, and has a specified mounting direction with respect to a vehicle (see JP 2021-126948 A, for example).

A tire having a specified mounting direction with respect to a vehicle generally has a high-performance design with excellent driving performance such as grip performance compared to a tire without a specified mounting direction. Note that a tread pattern disclosed in JP 2021-126948 A has lateral grooves, formed in a shoulder block, connecting to a main groove.

### SUMMARY

The tire disclosed in JP 2021-126948 A has the lateral grooves, each having the same depth as a main groove, communicating to the main groove, resulting in good drainage performance. Contrarily, the present inventor has found that such a tire has decreased cornering power characteristics (hereinafter referred to as “CP characteristics”) compared to tires that have the lateral grooves not communicating to the main groove. Therefore, it is an important problem to improve CP characteristics while ensuring good drainage performance in high-performance tires having specified mounting direction with respect to a vehicle.

A pneumatic tire according to the present disclosure, having a specified mounting direction with respect to a vehicle, includes a tread, wherein the tread includes: a first main groove that extends in a circumferential direction and is located on a vehicle outer side when the pneumatic tire is mounted on the vehicle; and a first shoulder block that is defined by the first main groove and disposed on the vehicle outer side, the first shoulder block being formed with a first lateral groove that extends in a direction crossing the first main groove and connects to the first main groove, the first lateral groove inside having a region adjacent to the first main groove, the region being formed with a protrusion that is a raised groove bottom, and the first lateral groove having an edge having a first incision along a length direction of the first lateral groove at least in an area where the protrusion is formed.

According to the pneumatic tire according to the present disclosure, it is possible to achieve excellent CP characteristics while ensuring good drainage performance.

### BRIEF DESCRIPTION OF DRAWINGS

An embodiment of the present disclosure will be described based on the following figures, wherein:

FIG. 1 is a perspective view of a pneumatic tire that is an example of an embodiment;

FIG. 2 is a plan view of a pneumatic tire that is an example of an embodiment, showing an enlarged view of a part of a tread;

FIG. 3 is a cross-sectional view taken along a line AA in FIG. 2;

FIG. 4 is an enlarged perspective view of a first shoulder block and a second rib;

FIG. 5 is a plan view showing an enlarged lateral groove of the first shoulder block;

FIG. 6 is a cross-sectional view taken along a line BB in FIG. 5; and

FIG. 7 is a cross-sectional view of the tread cut in a length direction of the lateral groove.

### DESCRIPTION OF EMBODIMENT

Hereinafter, an example of an embodiment of a pneumatic tire according to the present disclosure will be described in detail with reference to the drawings. The embodiment described below is merely an example, and the present disclosure is not limited to the following embodiment. In addition, the present disclosure includes forms in which components of the embodiment described below are selectively combined.

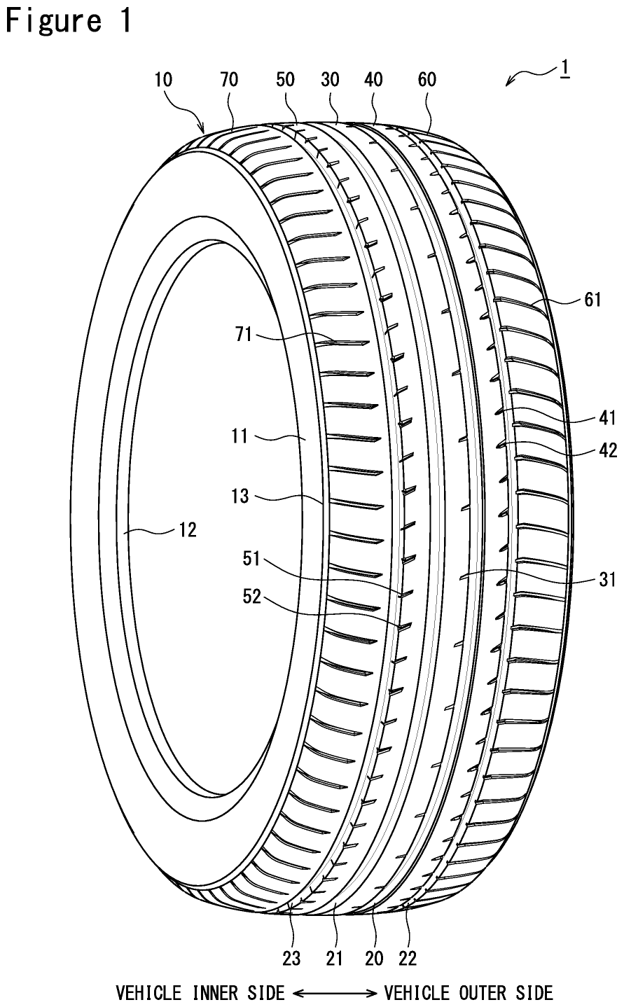

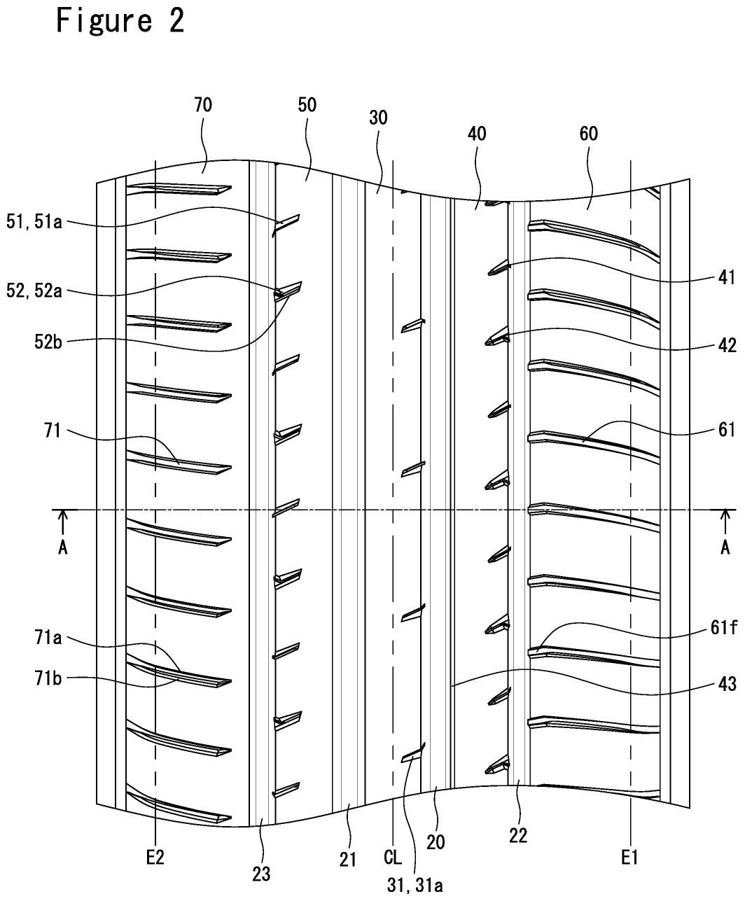

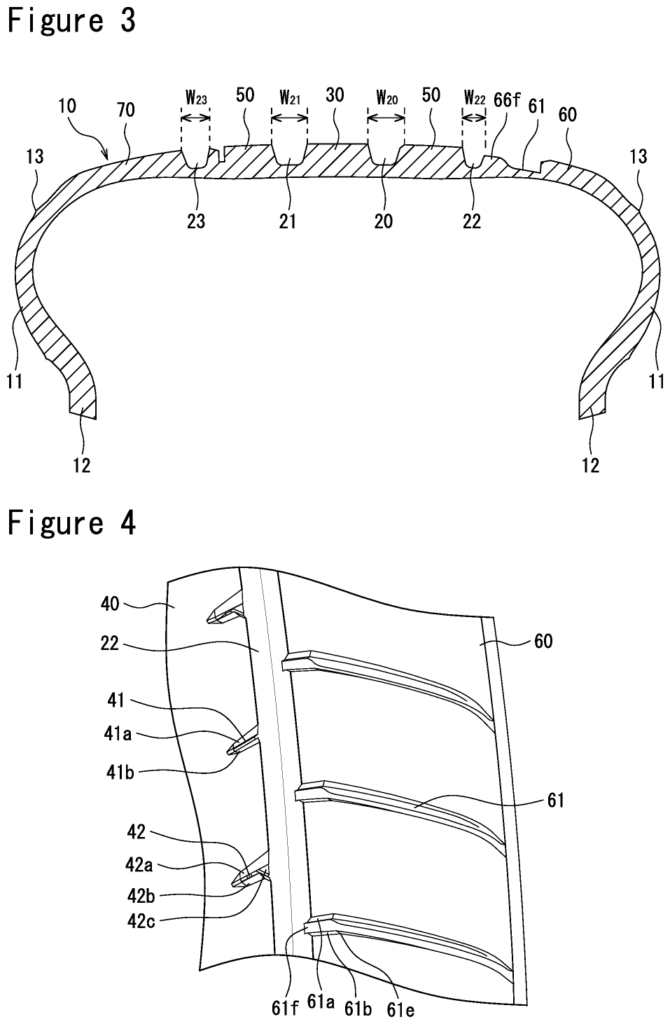

FIG. 1 is a perspective view of a pneumatic tire 1 that is an example of an embodiment, and FIG. 2 is a plan view of the pneumatic tire 1. FIG. 3 is a cross-sectional view taken along a line AA in FIG. 2. As shown in FIGS. 1 to 3, the pneumatic tire 1 includes a tread 10 disposed between a pair of tread ends. The tread 10 has at least a shoulder block 60 disposed on the vehicle outer side, and a first main groove 22 that is disposed adjacent to the shoulder block 60 and extends in the tire circumferential direction. The tread 10 is formed in an annular shape along the tire circumferential direction. As will be described later in detail, the first shoulder block 60 is formed with lateral grooves 61 that extend in a direction crossing the main groove 22 and connect to the main groove 22, and the lateral grooves 61 each have a region, adjacent to the main groove 22, being formed with a protrusion 61f that is a raised groove bottom.

The tread 10 is formed with a plurality of main grooves that are a first main groove 22, a second main groove 23, a third main groove 20, and a fourth main groove 21. Although the number of main grooves is not particularly limited, four main grooves 20, 21, 22, and 23 are formed in the present embodiment. The four main grooves 20, 21, 22, 23 are formed straight in the tire circumferential direction without bending in the tire axial direction. Each main groove may have the same width and depth, and in the present embodiment, at least the widths of the main grooves 20 and 21 are different from the widths of the main grooves 22 and 23. Having four main grooves further enhances an effect of improving drainage performance.

The pneumatic tire 1 is a tire having a specified mounting direction with respect to the vehicle, and has the opposite mounting directions on the right side and the left side of the vehicle. The tread 10 has different tread patterns on the left and right sides of a tire equator CL. The equator CL is an imaginary line in the tire circumferential direction, and the equator CL passes through the center of the tread 10 in the tire axial direction. In the present description, the term “left and right” is used for convenience of explanation, and the term “left and right” means left and right in the traveling direction of the vehicle with the pneumatic tire 1 mounted on the vehicle. The pneumatic tire 1 is suitable, for example, for summer tires for electrically powered vehicles such as electric vehicles (EV) and hybrid vehicles (HV) with high acceleration performance, or heavy sports utility vehicles (SUV).

The tread 10 has a first rib 30, a second rib 40, a third rib 50, a first shoulder block 60 and a second shoulder block 70, which are defined by the four main grooves. The ribs and blocks are portions that protrude outward in the tire radial direction from a position corresponding to the bottom of the main groove, and are also called lands. In general, the rib of the tread means a land having a narrow width sandwiched between main grooves and continuously formed in an annular shape in the tire circumferential direction. A block means a land wider than a rib or a land intermittently formed in the tire circumferential direction.

The tread 10 has main grooves 22, a shoulder block 60, a main groove 23, and a shoulder block 70 when the pneumatic tire 1 is mounted on a vehicle. The main groove 22 is located on the vehicle outer side and extends in the circumferential direction. The shoulder block 60 is defined by the main groove 22 and disposed on the vehicle outer side. The main groove 23 is located on the vehicle inner side and extends in the circumferential direction. The shoulder block 70 is defined by the main groove 23 and disposed on the vehicle inner side. In other words, the pneumatic tire 1 is mounted on the vehicle so that the shoulder block 60 is positioned on the vehicle outer side and the shoulder block 70 is positioned on the vehicle inner side. The first rib 30 is formed on the equator CL, the second rib 40 is formed between the rib 30 and the shoulder block 60, and the third rib 50 is formed between the rib 30 and the shoulder block 70.

The pneumatic tire 1 includes a pair of sidewalls 11 that are convex outward in the tire axial direction and a pair of beads 12. Each bead 12 is a portion that is fixed to the rim of the wheel and has, for example, a bead core and a bead filler. The sidewalls 11 and the beads 12 are annularly formed along the tire circumferential direction and constitute the side surfaces of the pneumatic tire 1. The sidewalls 11 extend in the tire radial direction from the respective ends in the tire axial direction of the tread 10.

The pneumatic tire 1 may have side ribs 13, one of which is formed between one ground contact end E1 of the tread 10 and a part where one sidewall 11 protrudes furthest outward in the tire axial direction, and the other of which is formed between the other ground contact end E2 of the tread 10 and a part where the other sidewall 11 protrudes furthest outward in the tire axial direction. Note that the ground contact end E1 is on the vehicle outer side, and the ground contact end E2 is on the vehicle inner side, and they are respectively on the shoulder blocks 50 and 60. Each side rib 13 protrudes outward in the tire axial direction and is annularly formed along the tire circumferential direction. The portions from the ground contact ends E1 and E2 of the pneumatic tire 1 or their vicinity to the left and right side ribs 13 are also called shoulders or buttress regions.

The tread 10 and sidewalls 11 are generally made of different types of rubber. The shoulders may be made of the same rubber as the tread 10, or may be made of a different rubber. In the present description, the ground contact ends E1 and E2 are respectively defined as ends in the tire axial direction of a region (ground contact surface) in contact with a flat road surface when a predetermined load is applied to an unused pneumatic tire 1 that is mounted on a regular rim and is filled with air at a regular internal pressure. In the case of tires for passenger vehicles, the predetermined load corresponds to 88% of the regular load.

Here, the “regular rim” is a rim defined by tire standards, and is a “standard rim” in JATMA, and a “measuring rim” in TRA and ETRTO. The “regular internal pressure” is the “maximum air pressure” in JATMA, the maximum value described in the table “TIRE LOAD LIMITS AT VARIOUS COLD INFLATION PRESSURES” in TRA, and the “INFLATION PRESSURE” in ETRTO. The regular internal pressure is usually 180 kPa for tires for passenger vehicles, and it is 220 kPa for tires labeled as Extra Load or Reinforced. The “regular load” is the “maximum load capacity” in JATMA, the maximum value described in the table “TIRE LOAD LIMITS AT VARIOUS COLD INFLATION PRESSURES” in TRA, and the “LOAD CAPACITY” in ETRTO.

A pneumatic tire 1 includes, for example, a carcass, a belt, and an inner liner. The carcass is a cord layer covered with rubber and forms the framework of the pneumatic tire 1 that withstands load, impact, air pressure, and the like. The belt is a reinforcing strip that is disposed between the rubber that makes up the tread 10 and the carcass. The belt tightens the carcass and enhances the rigidity of the pneumatic tire 1. The inner liner is a rubber layer provided on the inner circumferential surface of the carcass and retains the air pressure of the pneumatic tire 1.

Since the pneumatic tire 1 is used as a tire having a specified mounting direction with respect to the vehicle, the pneumatic tire 1 preferably has an indication for indicating the mounting direction with respect to the vehicle. The indication indicating the mounting direction may be characters, symbols, illustrations, or the like indicating the vehicle inner side or vehicle outer side, and its configuration is not particularly limited. In general, the pneumatic tire 1 has a symbol called serial on the side surface, and the serial may be used as an indication indicating the mounting direction.

The serial includes information such as the size code, the manufacturing time (manufacturing year and week), and the manufacturing location (manufacturing plant code). A serial may be provided only on the side surface (sidewall 11) of the pneumatic tire 1 facing the outside of the vehicle, or different serials may be provided on the side facing the outside and the side facing the inside of the vehicle, to specify the mounting direction of the pneumatic tire 1 with respect to the vehicle. As a specific example, a manufacturing plant code and a size code are provided on each side surface of the pneumatic tire 1, and a manufacturing year and week is provided only on the side surface facing the outside of the vehicle.

The tread pattern of the pneumatic tire 1 will be described in detail below with reference to FIGS. 2 and 3.

As shown in FIGS. 2 and 3, the tread 10 has a rib 30, which is a center rib formed on the center in the tire axial direction, and has a tread pattern that is left-right asymmetric with respect to the equator CL. Hereinafter, the region on the side of the ground contact end E1 relative to the equator CL is referred to as a first region, and the region on the side of the ground contact end E2 relative to the equator CL is referred to as a second region. The tread pattern of the pneumatic tire 1 can achieve low air resistance and excellent CP characteristics while ensuring good drainage performance when the tire is mounted on the vehicle so that the first region is positioned on the vehicle outer side and the second region is positioned on the vehicle inner side. As described above, the pneumatic tire 1 is a summer tire that is used on road surfaces free from ice and snow, and is suitable for EVs, HVs, or SUVs.

In the first region of the tread 10, shoulder block 60, rib 40, and rib 30 are formed in this order from the side of the ground contact end E1. The first region is formed with two main grooves 20 and 22, and the main groove 20 divides the rib 30 from the rib 40 and the main groove 22 divides the rib 40 from the shoulder block 60. In the second region of the tread 10, the shoulder block 70, rib 50, and rib 30 are formed in this order from the side of the ground contact end E2. The second region is formed with two main grooves 21 and 23, and the main groove 21 divides the rib 30 from the rib 50 and the main groove 23 divides the rib 50 from the shoulder block 70.

In the present embodiment, each of the four main grooves and the three ribs has a constant width over the entire length, and the rib 30 is formed so that the central position in the width direction of the rib 30 is located on the equator CL. Therefore, the main grooves 20 and 21 are disposed to be adjacent to the rib 30 on the respective side in the tire axial direction, and are formed at positions equidistant from the equator CL. The three ribs 30, 40 and 50 each have substantially the same width. In the present description, unless otherwise specified, “substantially the same” means exactly the same and substantially the same (the same applies to substantially constant, substantially parallel, etc.).

The four main grooves 20, 21, 22, and 23 may be formed with the same width. However, in the present embodiment, the individual widths W₂₀ and W₂₁ of the main grooves 20 and 21 disposed to be adjacent to the rib 30 are larger than the individual widths W₂₂ and W₂₃ of the main grooves 22 and 23 respectively disposed to be adjacent to the shoulder blocks 60 and 70. In the present description, the width of the groove means the width along a profile surface α (see FIG. 6 to be described later) along the ground contact surface of the tread 10, unless otherwise specified. In the tread 10, the central region near the equator CL has a longer contact length, which is the length in contact with the road surface in the tire circumferential direction, than the regions near the ground contact ends E1 and E2. For this reason, forming the main grooves 20 and 21 to be wide, for example, ensures good drainage performance in the central region, and improves wet braking performance.

The main grooves 20 and 21 may have the same width. The main groove 23 may be formed with a wider width than the main groove 22. An example of widths W₂₀ and W₂₁ are each 13.0 to 15.0 mm. An example of the width W₂₂ is 9.0 to 11.0 mm, and an example of the width W₂₃ is 10.5 to 12.5 mm. The walls of each main groove incline so that the groove width gradually narrows toward the groove bottom. The walls of the main grooves form the side walls of the ribs and blocks. Therefore, in other words, the ribs and blocks have side walls that incline to be wider going away from the ground contact surface.

The four main grooves 20, 21, 22, and 23 may be formed with the same depth, or the main grooves 20 and 21 may be formed deeper than the main grooves 22 and 23. The depth of the groove means the depth of the deepest part of the groove unless otherwise specified. More specifically, the depth of the groove means the shortest distance from the profile surface α to the groove bottom of the deepest part. The depths of main grooves are, for example, 7.8 to 8.2 mm for the main grooves 20 and 21 and 7.3 to 7.7 mm for the main grooves 22 and 23. At least one of the four main grooves is typically provided with a wear indicator (not shown). The wear indicator is a projection disposed at the groove bottom and serves as an index for checking the wear level of the tread rubber. Sipes and lateral grooves to be described later are generally formed deeper than the upper surface of the wear indicator.

The three ribs 30, 40, and 50 are formed with a plurality of sipes at intervals in the tire circumferential direction. In the present description, a sipe means a narrow groove narrower than the lateral grooves 61 and 71 formed in the shoulder blocks 60 and 70, and means a groove having a groove width of 1.0 mm or less at a part that does not includes an incision to be described later. In the pneumatic tire 1, the sipes serve for adjusting the rigidity of the ribs, for example, and contribute to achieving both good ride comfort and braking performance. In the present embodiment, the rib 30 is formed with one type of sipe 31, and ribs 40 and 50 are each formed with two types of sipes.

The three ribs 30, 40, and 50 are formed with no sipes crossing the ribs. Each sipe has one end connecting to only one of the two adjacent main grooves and the other end terminating in the rib. The rib 30 is formed with the sipes 31 each extending from the main groove 20 and not reaching the equator CL. The rib 30 is formed with no sipes extending from the main groove 21. The rib 40 has two types of sipes 41 and 42 extending from the main groove 22. The sipes 41 and 42 are alternately formed in the tire circumferential direction. The rib 50 has two types of sipes 51 and 52 extending from the main groove 23. The sipes 51 and 52 are alternately formed in the tire circumferential direction.

As described above, the shoulder block 60 is formed with first lateral grooves 61 extending in the tire axial direction. The shoulder block 70 is formed with second lateral grooves 71 extending in the tire axial direction. In the present description, the expression that the lateral grooves (as well as the sipes) “extend in the tire axial direction” means both a geometry in which the lateral grooves extend in the tire axial direction and a geometry in which the lateral grooves extend at an inclination angle of 45° or less, preferably 30° or less, with respect to the tire axial direction. The same applies to the main grooves each extending in the tire circumferential direction, and the main grooves may be formed in a zigzag shape while bending at an inclination angle of 45° or less with respect to the tire circumferential direction.

Lateral grooves 61 of the shoulder block 60 connect to the main groove 22. In this respect, the lateral grooves 61 differ from the lateral grooves 71 of the shoulder block 70 that do not connect to the main grooves 23 but terminate within the block. The shoulder block 60 has a ground contact surface divided in the tire circumferential direction by lateral grooves 61. In contrast, the shoulder block 70 does not have a groove crossing the ground contact surface of the block, and has a continuous ground contact surface in the tire circumferential direction. As will be described later in detail, formation of the lateral grooves 61 communicating to the main grooves 22 greatly improves drainage performance.

Each of the ribs 30, 40, 50 and the shoulder blocks 60, 70 that configure the tread pattern will be described in further detail below.

### Rib 30

As shown in FIG. 2, the rib 30 is a center rib disposed on the equator CL and has a plurality of sipes 31 formed only on the vehicle outer side relative to the equator CL. The rib 30 has a ground contact surface having, for example, a width corresponding to 10% to 15% of the length from ground contact end E1 to ground contact end E2 in the tire axial direction in a plan view of the tread 10 (hereinafter referred to as “tire ground contact width”). The center rib 30 having a width within this range makes it easy to achieve both good braking performance and good drainage performance. An example width of the center rib 30 is 23.5 to 25.5 mm.

Each sipe 31 extends from the main groove 20 in the tire axial direction and terminates in the rib 30. The sipe 31 inclines, for example, at an angle of 5° to 30° with respect to the tire axial direction. In addition, the sipe 31 is formed to extends from the main groove 20 and not reach the equator CL (central position in the width direction of the rib 30). The length of the sipe 31 along the tire axial direction is preferably 20 to 45% of the width of the rib 30. The width of the sipe 31 is, for example, 0.5 to 1.0 mm. In the present description, the width of each sipe and lateral groove means width excluding incisions unless otherwise specified. The sipe 31 is shallower than the main groove 20. The depth of the sipe 31 may be 70% to 90% of the depth of the main groove 20.

The plurality of sipes 31 may be formed at the same intervals, but are preferably formed at variable-pitch intervals in which the intervals between the sipes are slightly changed in the tire circumferential direction in a unit of a predetermined number. In this case, resonance can be avoided by varying the frequency of pitch noise caused by the sipes, so that the noise is reduced. Although the number of sipes 31 is not particularly limited, it is 30 to 40, as an example. The individual intervals between the sipes 31 are wider than the individual intervals between the sipes formed on the ribs 40 and 50, and the number of the sipes 31 is less than the individual numbers of the sipes formed on ribs 40 and 50. The number of sipes 31 may be 30 to 50% of the individual numbers of sipes formed on the ribs 40 and 50.

The rib 30 is formed with an incision 31a at an edge of the sipe 31 along a length direction. Similarly to first incisions 61a and 61b, which will be described later, each incision 31a is formed so that the edge of the sipe 31 is chamfered to be widened in a predetermined depth range from the ground contact surface of the rib 30. The incision 31a, for example, disperses the ground contact pressure acting on the edge of the sipe 31 and contributes to the improvement of the driving performance. Although the incision may be formed on each side of the sipe 31 in the width direction, in the present embodiment, the incision 31a is formed only on one side of the sipe 31 in the width direction.

A slope forming each incision 31a is inclined at an angle of 30° to 60° or 40° to 50°, at the widest part, with respect to the profile surface α along the ground contact surface of the tread 10, for example. In this case, the function of the incision 31a is exhibited more effectively, and the slope is brought into contact with the road surface at a time of sudden braking or sudden acceleration, thereby preventing the collapse of the block. The incision 31a (slope) may be formed over the entire length of the sipe 31 or may be wider as it is closer to the main groove 20. The incision 31a is formed, for example, within a depth range corresponding to 30% of the depth of the deepest part of the sipe 31 from the ground contact surface of the rib 30. In this case, the driving performance can be improved without loss of the durability of the rib 30.

### Rib 40

The rib 40 is opposed to the rib 30 in the tire axial direction across the main groove and is opposed to the shoulder block 60 in the tire axial direction across the main groove 22 in the first region on the vehicle outer side. The width of the ground contact surface of the rib 40 may be, for example, the same as the width of the ground contact surface of the rib 30, or slightly smaller than the width of the ground contact surface of the rib 30, and may be 90 to 110% of the width of the contact surface of the rib 30. In addition, the rib 40 has an incision 43 such that the edge of the main groove 20 is chamfered to be widened. The slope forming the incision 43 inclines, for example, at an angle of 30° to 60° or 40° to 50° with respect to the profile surface a. The incision 43 (slope) is formed with a constant width over the entire length of the rib 40. In the present embodiment, the incision along the edge of the main groove is formed only on the rib 40.

The rib 40 is formed with two types of sipes 41 and 42 having different shapes. Each sipe 41 is formed in a linear shape over its entire length whereas each sipe 42 bends near the main groove 22. The sipe 42 is slightly longer than the sipe 41 in the tire axial direction. The sipes 41 and 42, like the sipe 31 of the rib 30, are formed only in a region on the vehicle outer side relative to the central position in the width direction of the rib 40, and extend from the main groove 22 and terminate in the rib 40 in the tire axial direction.

The sipes 41 and 42, for example, extend in substantially the same direction as the sipe 31, and incline at an angle of 5° to 30° with respect to the tire axial direction. The sipes 41 and 42 may each have a slightly larger inclination angle with respect to the tire axial direction than the sipe 31. In addition, the sipes 41 and 42 are each formed to extend from the main groove 22 and not reach the central position of the rib 40 in the width direction. The length of each of the sipes 41 and 42 in the tire axial direction is preferably 20 to 45% of the width of the rib 40. The sipes 41 and 42 each have a width of 0.5 to 1.0 mm, for example. The sipes 41 and 42 may each have a depth that is 70% to 90% of the depth of the deepest part of the main groove 22.

The sipes 41 and 42 are preferably alternately disposed at predetermined intervals in the tire circumferential direction in order to ensure good rigidity balance over the entire length of the rib 40. In addition, the sipes 41 and 42 are disposed in a staggered manner with the lateral grooves 61 of the shoulder block 60 in a plan view of the tread 10. In other words, in the tire circumferential direction, the sipes 41 and 42 and the lateral grooves 61 are disposed alternately with the main groove 22 interposed therebetween. Alternate disposal of the two types of sipes 41 and 42 having different shapes in the tire circumferential direction facilitates adjustment of the rigidity of the rib 40 to contribute to improvements in CP characteristics, braking performance, and the like.

The sipes 41 and 42 may have the same intervals therebetween, but preferably have variable-pitch intervals in which the intervals are slightly changed in a unit of a predetermined number. Although the number of sipes 41 and 42 is not particularly limited, it is 60 to 80 as an example. The total number of the sipes 41 and 42 is greater than the number of sipes 31 of rib 30, and in the present embodiment the individual numbers of the sipes 41 and 42 are the same as the number of sipes 31.

FIG. 4 is an enlarged perspective view showing the rib 40 and the shoulder block 60. As shown in FIG. 4, a projection 42c is formed in a region of each sipe 42 adjacent to the main groove 22. The projection 42c is a part where the groove bottom protrudes to an incision 42a, which will be described later, or to its vicinity, and has a triangular shape in a plan view. The deep part of the sipe 42 is bent by the projection 42c. The depth of the sipe 42 may be shallower in the region adjacent to the main groove 22 than in other regions.

The rib 40 has incisions 41a and 41b each formed in the edge of the sipe 41 along the length direction of the sipe 41, and has incisions 42a and 42b each formed in the edge of the sipe 42 along the length direction of the sipe 42. The incisions 41a and 41b are each formed so that the edge of the sipe 41 is chamfered to be widened within a predetermined depth range from the ground contact surface of the rib 40. Likewise, the incisions 42a and 42b are each formed so that the edge of the sipe 42 is chamfered to be widened within a predetermined depth range from the ground contact surface of the rib 40. For example, the incisions effectively disperse the ground contact pressure of the ribs 40 to improve driving performance.

In the present embodiment, incisions 41a and 41b are formed on the respective sides of the sipe 41 in the width direction, and incisions 42a and 42b are formed on the respective sides of the sipe 42 in the width direction. Each incision bends at one end edge part in the length direction of the sipes 41 and 42 on the opposite side of the main groove 22, and has a width gradually decreasing with increasing distance from the bending part. On the other hand, each incision may widen from the bending part toward the main groove 22. Each slope forming the incision of the rib 40 may incline at substantially the same angle as each slope forming the incision 31a with respect to the profile surface a at the part where the incision has the maximum width. Further, the incisions (slopes) are preferably formed within depth ranges corresponding to 30% of the depths of the deepest parts of the respective sipes 41 and 42 from the ground contact surface of the rib 40.

### Rib 50

The rib 50 is opposed to the rib 30 in the tire axial direction across the main groove 21 and is opposed to the shoulder block 70 in the tire axial direction across the main groove 23 in the second region on the vehicle inner side. The width of the ground contact surface of the rib 50 may be the same as the width of the ground contact surface of the rib 30. The rib 50 is formed with two types of sipes 51 and 52 having different shapes. The sipes 51 and 52 each extend in the tire axial direction from the main groove 23 and terminate in the rib 50. Each rib has a main groove located on each side, and the sipes of the ribs 30 and 40 communicate to the main grooves on the vehicle outer side, whereas the sipes 51 and 52 communicate with the main groove on the vehicle inner side.

The sipes 51 and 52 are each formed to extend from the main groove 23 and not reach the central position in the width direction of the rib 50. In other words, each of the sipes 51 and 52 is formed only in the region on the vehicle inner side relative to the central position of the rib 50 in the width direction. The length of each of the sipes 51 and 52 in the tire axial direction is preferably 20 to 45% of the width of the rib 50. Each sipe 51 may extend straight in substantially the same direction as the sipe 41 and may be formed on the same straight line as the sipe 41. Each sipe 52 bends near the main groove 23 like the sipe 42, but the linearly extending part may be formed on the same straight line as the sipe 42. The depth of the sipes 51 and 52 may each be 70% to 90% of the depth of the deepest part of the main groove 23.

Preferably, the sipes 51 and 52 are alternately disposed at intervals in the tire circumferential direction, like the sipes 41 and 42. In addition, the sipes 51 and 52 are disposed in a staggered manner with the lateral grooves 71 of the shoulder block 70 in a plan view of the tread 10. In other words, in the tire circumferential direction, the sipes 51 and 52 and the lateral grooves 71 are disposed alternately with the main groove 23 interposed therebetween. The sipes may have the same intervals, but preferably have variable-pitch intervals in which the intervals are slightly changed in a unit of a predetermined number. In the present embodiment, the number of sipes 51 and 52 is the same as the number of sipes 41 and 42.

The rib 50 has incisions 51a each formed in an edge of the sipe 51 along the length direction of the sipe 51, and has incisions 52a and 52b each formed in the edge of the sipe 52 along the length direction of the sipe 52. Each incision is formed in a predetermined depth range from the ground contact surface of the rib 50 (for example, a depth range corresponding to 30% of the depth of the deepest part of the sipe) so that the edge of the sipe is chamfered to be widened. For example, the incisions effectively disperse the ground contact pressure of the ribs 50 to improve driving performance. Each slope forming the incision of the rib 50 may incline at substantially the same angle as each slope forming the incision 31a with respect to the profile surface a at the part where the incision has the maximum width.

The planar view shape of each sipe 51 is similar to the planar view shape of the sipe 41 turned 180° with respect to the equator CL. However, the sipe 51 has the incision 51a formed only on one side in the width direction. In this point, the sipe 51 differs from the sipe 41 having the incisions 41a and 41b formed on the respective sides in the width direction. Further, the rib 30 is formed with each of the incisions 31a at the edge located on one side in the tire circumferential direction of the sipe 31, whereas the rib 50 is formed with each incision 51a at the edge located on the other side in the tire circumferential direction of the sipe 51.

The planar view shape of each sipe 52 is similar to the planar view shape of the sipe 42 turned 180° with respect to the equator CL. However, the shapes of the incisions formed at the edges of the different sipes are different from each other. For example, each incision 42a formed at the edge of the sipe 42 widens toward the main groove 22, whereas each incision 52b formed at the edge of the sipe 52 has a substantially constant width over the entire length of the sipe 52.

### Shoulder Block 70

The shoulder block 70 is disposed parallel to the rib 50, across the main groove 23, in the second region on the vehicle inner side. The width of the ground contact surface of the shoulder block 70 is, for example, 15% to 25% of the ground contact width of the tire, and is larger than the width of the ground contact surface of any rib. The width of the ground contact surface of the shoulder block 70 may be the same as the width of the ground contact surface of the shoulder block 60, but is smaller than the width of the ground contact surface of the shoulder block 60 in the present embodiment.

The shoulder block 70 is formed with a plurality of lateral grooves 71 extending in a direction crossing the main groove 23 at intervals in the tire circumferential direction. As described above, the lateral groove 71 terminates in the shoulder block 70 without connecting to the main groove 23. Therefore, the ground contact surface of the shoulder block 70 is continuous in the tire circumferential direction. In this case, compared with a case in which the lateral groove communicates with the main groove 23, the drainage performance decreases slightly, but the braking performance improves significantly. In addition, the effect of reducing air resistance and noise can be obtained. In the present embodiment, the width W₂₃ of the main groove 23 is made larger than the width W₂₂ of the main groove 22 on the vehicle outer side in order to prevent decrease of the drainage performance in the second region.

The lateral grooves 71 are preferably formed at variable-pitch intervals, like the sipes of other ribs. The number of lateral grooves 71 is, for example, the same as the number of sipes formed in the rib 50. Each lateral groove 71 is formed with a substantially constant width, for example, except near both ends in the length direction. The width of the lateral groove 71 at both ends in the length direction may gradually decreases toward one end on the side of the main groove 23 in the length direction, and gradually increases toward the other end on the side of the side rib 13 in the length direction. The depth of the lateral groove 71, at the deepest part, may be substantially the same as the depth of the main groove 23 or may be 70% to 95% of the depth of the main groove 23. The lateral groove 71 is deepest from one end in the length direction on the side of the main groove 23 to a position corresponding to the ground contact end E2.

Each lateral groove 71 extends from a position closer to the main groove 23 than the ground contact end E2 to the vicinity of the side rib 13 beyond the ground contact end E2. The lateral groove 71 inclines at an angle of 5° to 25° with respect to the tire axial direction. The lateral groove 71 inclines with respect to the tire axial direction so that one end in the length direction is located on one side in the tire circumferential direction relative to the other end on the side of the side rib 13 in the length direction. Note that each sipe 51 of the rib 50 inclines so that one end on the equator CL side in the length direction is located on the other side in the tire circumferential direction relative to the other end on the side of the main groove 23 in the length direction. The above means that the lateral groove 71 inclines in a direction opposite to the sipe 51 in the tire axial direction.

In the shoulder block 70, each lateral groove 71 has second incisions 71a and 71b respectively formed at the edges in the length direction of the lateral groove 71. Although the incisions may be formed only on one side of the lateral groove 71 in the width direction, the incisions are formed on both sides of the lateral groove 71 in the width direction in the present embodiment. Each incision is formed in a predetermined depth range from the ground contact surface of the shoulder block 70 (for example, a depth range corresponding to 30% of the depth of the deepest part of the lateral groove 71) so that the edge of the lateral groove 71 is chamfered to be widened. For example, the incisions effectively disperse the ground contact pressure of the shoulder block 70 to improve driving performance.

The incisions 71a and 7b may each be formed along the length direction of the lateral groove 71 from one end on the side of the main groove 23 in the length direction to a position beyond the ground contact end E2, or may each be formed over the entire length of the lateral groove 71. The slopes forming the incisions 71a and 71b may each incline at an angle similar to the slope forming the incision 31a of the rib 30 with respect to the profile surface α.

### Shoulder Block 60

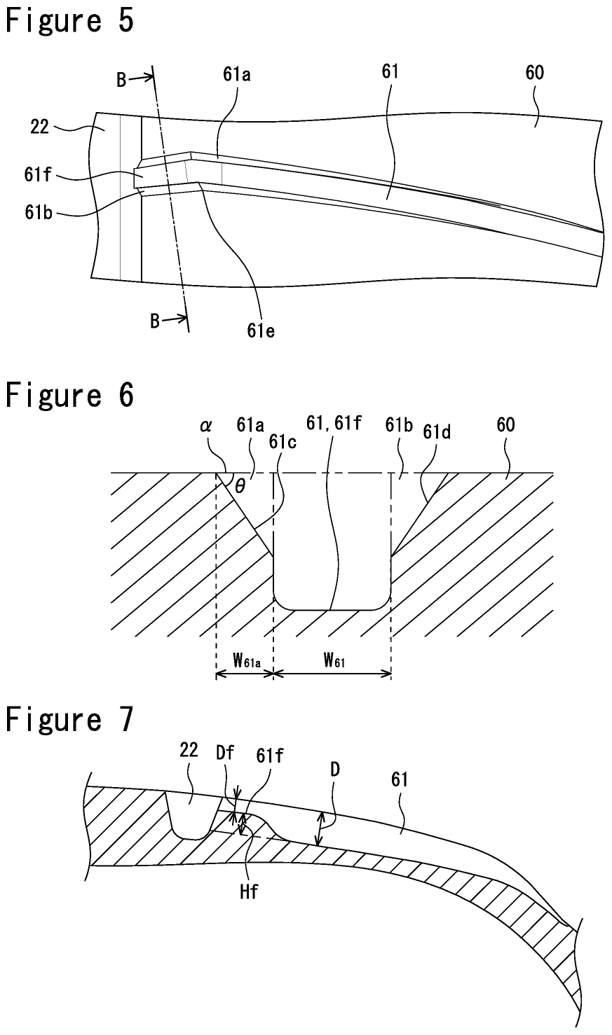

The shoulder block 60 will be described in detail below with further reference to FIGS. 4 to 7. FIG. 5 is an enlarged plan view showing a part of the shoulder block 60 where the lateral groove 61 is formed, and FIG. 6 is a cross-sectional view taken along a line BB in FIG. 5. FIG. 7 is a cross-sectional view of the tread 10 cut in the length direction of the lateral grooves 61.

As shown in FIG. 4, the shoulder block 60 is disposed parallel with the rib 40 across the main groove 22 in the first region on the vehicle outer side. The width of the ground contact surface of the shoulder block 60 is, for example, 15% to 25% of the ground contact width of the tire. In the present embodiment, the width of the ground contact surface of the shoulder block 60 is slightly larger than the width of the ground contact surface of the shoulder block 70 in the range of 15% to 25% of the ground contact width of the tire. The ground contact area of the first region on the vehicle outer side is slightly larger than the ground contact area of the second region on the vehicle inner side. In this case, CP characteristics can be improved more effectively.

The shoulder block 60 is formed with a plurality of lateral grooves 61 extending in a tire circumferential direction at intervals in the tire circumferential direction. Each lateral groove 61 is formed to extend from the main groove 22 beyond the ground contact end E1 and crosses the ground contact surface of the shoulder block 60. In this case, the drainage performance in the first region significantly improves, compared to a case in which the lateral grooves do not communicate with the main groove 22. In contrast, in this case, the amount of air flowing from the main groove 22 to the outside of the vehicle through the lateral grooves 61 increases compared to a case in which the lateral grooves do not communicate with the main groove 22. This tends to increase air resistance and noise. Further, this is likely to twist the shoulder block 60 and decrease the CP characteristics.

Therefore, in order to achieve excellent CP characteristics while ensuring good drainage performance, the pneumatic tire 1 has the lateral grooves 61 each provided with a protrusion 61f that is a raised groove bottom in a region adjacent to the main groove 22. In addition, in the shoulder block 60, each lateral groove 61 has first incisions 61a and 61b that are formed at the respective edges in the width direction of the lateral groove 61 and are formed along the length direction of the lateral groove 61 at least in the area where the protrusion 61f is formed. As will be described later in detail, the protrusion 61f is formed preferably with a height corresponding to 30% to 70%, more preferably 40% to 70%, of the depth of the deepest part of the lateral groove 61. In this case, the above effects appear more significantly, and the air resistance is effectively reduced.

The lateral grooves 61 are preferably formed at variable-pitch intervals, similarly to the sipes of each rib and the lateral grooves 71. The number of lateral grooves 61 is, for example, the same as the number of sipes formed in each of the ribs 40 and 50 and the number of lateral grooves 71. In the present embodiment, each lateral groove 61 has a bend 61e formed in a region adjacent to the main groove 22 so that the lateral groove 61 bends to protrude slightly to the other side in the tire circumferential direction. The width of the lateral groove 61 may decrease toward the main groove 22 from the bend 61e. The lateral groove 61 has, for example, a substantially constant width at least from the bend 61e to the ground contact end E1.

Each lateral groove 61 extends from the main groove 22 to the vicinity of the side rib 13 beyond the ground contact end E1. The lateral groove 61 may extend in the tire axial direction. However, in the present embodiment, the part located on the vehicle outer side relative to the bend 61e may incline at an angle of 5° to 25° with respect to the tire axial direction, and may incline in the same direction as the lateral grooves 71. The depth of the lateral groove 61, at the deepest part, may be substantially the same as the depth of the main groove 22, or may be 70% to 95% of the depth of the main groove 22. The lateral groove 61 is formed deepest between the end of the protrusion 61f and the position corresponding to the ground contact end E1.

As shown in FIGS. 5 to 7, each protrusion 61f is formed in the lateral groove 61 in a region adjacent to the main groove 22. For example, in a case in which the length of the lateral groove 61 in the tire axial direction from one end in the length direction, which is the intersection with the main groove 22, to the ground contact end E1 (≈ ground contact width of shoulder block 60) is defined as “length L”, the protrusion 61f is formed within 30% of the length L from one end in the length direction of the lateral groove 61.

Preferably, the height Hf of each protrusion 61f gradually decreases toward the ground contact end E1 so as to form no large step at the groove bottom. The part where the protrusion 61f has a height Hf exceeding 40% of the depth D of the deepest part of the lateral groove 61 preferably has a length of 10% to 25% of the length L of the lateral groove 61 in the tire axial direction. This makes it possible to more effectively reduce air resistance and improve CP characteristics while preventing decrease in drainage performance. Further, the protrusion 61f is preferably formed by raising the entire groove bottom of the lateral groove 61 in the region adjacent to the main groove 22. In other words, the protrusion 61f is formed over the entire width of the lateral groove 61 so as to connect the opposing groove walls of the lateral groove 61 to each other.

Each protrusion 61f may be formed so that the height Hf is highest at one end in the length direction of the lateral groove 61 and the height gradually decreases as the distance from the one end in the length direction increases. However, in the present embodiment, the height Hf is substantially constant in a predetermined length range from one end in the length direction. The protrusion 61f includes a flat region and an inclining region. The flat region has a substantially constant height Hf and a substantially flat upper surface of the protrusion 61f (groove bottom in the region where the protrusion 61f is formed). The inclining region is continuous from the flat region and has an inclining upper surface such that the height Hf gradually decreases. An example of the length of the flat region is 10% to 25% of the length L1 of the lateral groove 61. The height Hf of the protrusion 61f is, for example, highest at one end in length direction of the lateral groove 61, and is maintained in a predetermined length range. In this case, the function of the protrusion 61f is more effectively exhibited.

The height Hf of each protrusion 61f corresponds to, for example, 30% to 70% of the depth D of the deepest part of the lateral groove 61, preferably 40% to 70% of the depth D. In the present embodiment, the deepest part of the lateral groove 61 is positioned on the side of the main groove 22 relative to the position corresponding to the ground contact end E1, and specifically, the deepest part is at the region adjacent to the protrusion 61f. The height Hf of the protrusion 61f is obtained by subtracting the depth Df at the region where the protrusion 61f is formed from the depth D of the deepest part. The depth Df is, for example, 30% to 70% of the depth D of the deepest part. The depth Df is preferably 25% to 55% of the depth of the main groove 22.

The protrusion 61f having a height Hf of 40% to 70% of the depth D makes it possible to achieve excellent CP characteristics and easily reduce air resistance while ensuring good drainage performance. The height Hf exceeding 70% of the depth D tends to decrease the drainage performance if the configurations of the incisions 61a and 61b are the same. The height Hf is more preferably 45% to 70%, particularly preferably 55% to 70%, of the depth D of the highest part. In this case, the effects of the protrusion 61f appear more significantly.

In the present embodiment, each protrusion 61f is formed with a height of 30% or more of the depth D only in the range from one end in the length direction of the lateral groove 61 to the bend 61e. Then, the height Hf of the protrusion 61f begins to be lower slightly on the side of the main groove 22 relative to the bend 61e, and the protrusion of the groove bottom ends within 30% of the length L from the main groove 22.

The shoulder block 60 is formed with incisions 61a and 61b along the length direction of the lateral groove 61 at the edges of the lateral groove 61. Although the incisions may be formed only on one side of the lateral groove 61 in the width direction, the incisions are preferably formed on both edges of the lateral groove 61 in the width direction. Each incision is formed so that the edge of the lateral groove 61 is chamfered to be widened within a predetermined depth range from the ground contact surface of the shoulder block 60. The incisions 61a and 61b make it possible, for example, to improve drainage performance while preventing decrease in CP characteristics. In addition, the incisions 61a and 61b disperse the ground contact pressure of the shoulder block 60 and improve driving performance such as CP characteristics.

The incisions 61a and 61b are each formed at least in an area where the protrusion 61f is formed. The incisions 61a and 61b may each be formed only in an area where the protrusion 61f is present, but are preferably formed over an area extending from one end in the length direction of the lateral groove 61 to a position beyond the ground contact end E1. The incisions 61a and 61b may be formed up to the upper surface of the protrusion 61f, but are preferably formed shallower than the depth Df of the region where the protrusion 61f is formed. The depth of the incisions 61a and 61b is preferably 50% to 90% of the depth Df, more preferably 55% to 80%. In this case, it is possible to more effectively achieve decrease in air resistance and improvement in CP characteristics while preventing decrease in drainage performance. Each of the incisions 61a and 61b may terminate between the ground contact end E1 and the other end in the length direction of the lateral groove 61.

A slope 61c forming each incision 61a inclines at an angle θ with respect to the profile surface α. Likewise, a slope 61d forming each incision 61b also inclines at an angle θ with respect to the profile surface α. The slopes may have the same inclination angles θ with respect to the profile surface α a at least at positions where the slopes face each other in the width direction of the lateral grooves 61. The angle θ is, for example, 30° to 60° or 40° to 50° in the area where the protrusion 61f is formed. In this case, the effects of the incisions 61a and 61b appear more significantly. The slopes 61c and 61d may each incline at substantially the same angle as the slope forming the incision 31a of the rib 30 with respect to the profile surface a at least in the area where the protrusion 61f is formed.

In a plan view of the tread 10, the incisions 61a and 61b narrow from the side of the main groove 22 toward the ground contact end E1. Each incision 61a is a region surrounded by the slope 61c, the profile surface α, and an imaginary line extending from the wall of the lateral groove 61 (the same applies to the incision 61b). Therefore, for example, the incisions 61a and 61b are gradually smaller as they progress from the side of the main groove 22 toward the ground contact end E1. In this case, the effects of the incisions 61a and 61b appear more significantly. In the present embodiment, the angle θ of the slopes 61c and 61d gradually increases and the depth gradually increases, and thereby the width of the incisions 61a and 61b narrows.

A width W₆₁ₐ of the incision 61a in a plan view of the tread 10 is, for example, 30% to 70% or 40% to 60% of a width W₆₁ of the lateral groove 61 in the area where the protrusion 61f is formed. The width W₆₁ₐ may be less than 10% of the width W₆₁ at ground contact end E1. Note that the width of the incision 61b may be the same as the width W₆₁ₐ of the incision 61a at a position where both incisions face each other in the width direction of the lateral groove 61. The incisions 61a and 61b are formed to be large in the region where the protrusion 61f is formed, and the incisions 61a and 61b are gradually made smaller toward the ground contact end E1. This can increase the ground contact area as much as possible to improve CP characteristics while ensuring good drainage performance.

### EXAMPLES

The present disclosure will be further described below with reference to examples, but the present disclosure is not limited to these examples.

### Example 1

A test tire A1 (tire size: 235/50R20 104W) is produced that has a tread pattern shown in FIGS. 1 to 7. The number of sipes 31, 41, 42, 51, and 52 in each rib is 35, and the number of lateral grooves 61 and 71 in each shoulder block is twice the number of sipes 31. The height Hf of the protrusion 61f in the lateral groove 61 is set to 2.0 mm (the depth D of the lateral groove 61: 6.0 mm, the depth Df: 4.5 mm, the depth of the lateral groove 61 at the ground contact end E1: 5.2 mm). Hf/D is 0.33. The length in the tire axial direction of the region where the height Hf is substantially constant is 6.7 mm from one end in the length direction of the lateral groove 61, and the total length of the protrusion 61f is 10.6 mm. The incisions 61a and 61b are formed so as to gradually narrow from the bend 61e toward the side of the ground contact end E1 over the area from the main groove 22 to a position beyond the ground contact end E1. In the area where the height Hf of the protrusion 61f is 2.0 mm, depth of each of the incisions 61a and 61b is 1.5 mm, and angle θ of the slopes 61c and 61d with respect to the profile surface α is 55°.

The sizes of the ribs, shoulder blocks, main grooves, lateral grooves, etc. of the above tread pattern are as follows.
The ground contact width of the tread 10: 186 mm
The ground contact width of each sipe 31: 7.7 mm
The length in the tire axial direction from the end of the shoulder block 60 on the main groove side to the end of the lateral groove: 62.4 mm
The length in the tire axial direction from the end of the shoulder block 70 on the main groove side to the end of the lateral groove: 59.5 mm
The width and depth of the main groove 20: 13.9 mm, 8.0 mm
The width and depth of the main groove 21: 14.4 mm, 8.0 mm
The width and depth of the main groove 22: 9.8 mm, 7.5 mm
The width and depth of the main groove 23: 11.5 mm, 7.5 mm

### Examples 2 to 5

Test tires A2 to A5 are produced in the same manner as in Example 1 except that the heights Hf of the protrusions 61f are changed so that the values of Hf/D are changed to the values shown in Table 1 (Examples 2 to 4) and that depth of each of the incisions 61a and 61b is changed to 2.5 mm.

### Comparative Example 1

A test tire B1 is produced in the same manner as in Example 1 except that the protrusion 61f and the incisions 61a, 61b are not formed.

### Comparative Examples 2 and 3

Test tires B2 and B3 are produced in the same manner as in Comparative Example 1, except that the lateral grooves 61 are provided with protrusions 61f so that the Hf/D values are set to the values shown in Table 1.

For each test tire of Examples and Comparative Examples, drainage performance, air resistance, and CP characteristics are evaluated through the following methods. Table 1 shows the evaluation results.

### Evaluation of Drainage Performance

Each test tire is rotated on a wet road surface with a water depth of 8 mm, and the speed when hydroplaning occurs is measured. The evaluation results shown in Table 1 are relative values when the evaluation result of the tire of Comparative Example 1 is set to 100. As the numerical value increases, the speed when the hydroplaning occurs increases and the hydroplaning resistance (drainage performance) increases.

Tire mounting conditions: air pressure: 250 kPa, load: 573 kgf (single wheel)

Note that a tire having poor drainage performance cannot remove the water from the inside of the ground contact surface with the road surface quickly enough during driving. The remaining water forms a water film between the road surface and the tire tread, causing the tire to lose its grip on the road surface and causing hydroplaning. Therefore, the speeds at which the hydroplaning occur are measured as indexes of drainage performance.

### Evaluation of Air Resistance (Cd Value)

The drag force (the force acting on a tire, placed in a flow of air, in the same direction as the flow in the direction parallel to the flow) is measured for each test tire, and the drag coefficient Cd is calculated from the following formula. Each drag force is obtained from the pressure difference between the front and rear tires by simulation.

Cd=D/(½ρU2S)

where: D is the generated drag force; ρ is the air density and is set to 1.225 [kg/m³]; U is a representative speed, which is the relative speed between the tire and the air, and is set to 27.8 [m/s]; and S is the representative area (front projected area) of the tire. The Cd values shown in Table 1 are relative values when the value of the test tire B1 is 100, and indicate that the air resistance decreases as the numerical value decreases.

### Evaluation of CP Characteristics

Each test tire is mounted on a regular rim (19×7.0), and a flat belt cornering tester is used to measure the cornering force (CF) at a steering angle of 1° under the conditions in which the air pressure is 250 kPa, the running speed is 80 km/h, and the load is 573 kgf. A vehicle can turn by balancing the centrifugal force with a lateral force that is approximated with the CF, and CP means the CF value when the slip angle (SA) is 1°. The CP values shown in Table 1 are relative values when the value of the test tire B1 is 100, and indicate that the CP increases as the numerical value increases.

TABLE 1

| | A1 | A2 | A3 | A4 | A5 | B1 | B2 | B3 |
|---|---|---|---|---|---|---|---|---|
| Hf/D | 0.33 | 0.42 | 0.58 | 0.67 | 0.58 | — | 0.58 | 1.00 |
| Incision | 1.5 mm | 1.5 mm | 1.5 mm | 1.5 mm | 2.5 mm | — | — | — |
| depth | | | | | | | | |
| Drainage | 101 | 101 | 100 | 99 | 101 | 100 | 98 | 96 |
| performance | | | | | | | | |
| Cd | 101 | 100 | 99 | 99 | 100 | 100 | 98 | 97 |
| CP | 101 | 101 | 102 | 102 | 101 | 100 | 103 | 105 |

As shown in Table 1, each tire of the examples, which is formed with protrusions 61f in each of the lateral groove 61 connecting to the main groove 22 of the shoulder block and is formed with incisions 61a and 61b along the length direction of each lateral groove 61 at the respective edges of the lateral groove 61, has good drainage performance, low air resistance, and excellent CP characteristics. Each tire of the examples has substantially the same level of drainage performance while having greatly improved CP characteristics, compared to the tire B1 of Comparative Example 1 that has no protrusion 61f and no incisions 61a and 61b. In addition, each tire of the examples has significantly improved drainage performance compared to the tire B4 of Comparative Example 3 that has the lateral grooves connecting to the main grooves.

The comparison between the tire A3 of Example 3 and the tire B2 of Comparative Examples 2 shows that, in order to achieve both good drainage performance and CP characteristics at a high level, it is important to form the incisions 61a and 61b in addition to the protrusion 61f. Furthermore, the comparison shows that control of the height Hf of each protrusion 61f within a range of 40% to 70% of the depth D of the lateral groove 61 makes it possible to effectively reduce air resistance and improve CP characteristics while ensuring good drainage performance.

Note that the above-described embodiment can be appropriately modified in design without impairing an advantage of the present disclosure. The tread pattern includes the above configuration of the four main grooves, the three ribs, the sipes formed on each rib, and the second shoulder block 70. Such a tread pattern is suitable for summer tires having low air resistance and excellent CP characteristics while ensuring good drainage performance. However, it is possible to change the configuration other than the configuration related to the first shoulder block 60 to other configurations to achieve the advantage of the present disclosure. For example, the number, shape, etc. of the sipes formed in each rib may be changed without impairing the advantage of the present disclosure.

However, the tread patterns shown in FIGS. 1 to 7 are patterns that exhibit the above effects more significantly as a whole. The pneumatic tire 1 including the tread pattern of the above embodiment has, for example, excellent braking performance on both dry and wet road surfaces and excellent steering stability at a time of sudden start, sudden braking, and sharp turn. Therefore, the pneumatic tire 1 is suitable for summer tires for EVs and HVs with high acceleration performance, and for SUVs with heavy vehicle weight.

### REFERENCE SIGNS LIST

1 pneumatic tire, 10 tread, 11 sidewall, 12 bead, 13 side rib, 20, 21, 22, 23 main groove, 30, 40, 50 rib, 31, 41, 42, 51, 52 sipe, 31a, 41a, 41b, 42a, 42b, 43, 51a, 52a, 52b, 61a, 61b, 71a, 71b incision, 42c projection, 61e bend, 61f protrusion, 60, 70 shoulder block, 61, 71 lateral groove, 61c, 61d slope, CL equator, E1, E2: ground contact end

1. A pneumatic tire having a specified mounting direction with respect to a vehicle, the pneumatic tire comprising a tread, wherein
the tread includes:
a first main groove that extends in a circumferential direction and is located on a vehicle outer side when the pneumatic tire is mounted on the vehicle; and
a first shoulder block that is defined by the first main groove and disposed on the vehicle outer side,
the first shoulder block being formed with a first lateral groove that extends in a direction crossing the first main groove and connects to the first main groove,
a region in the first lateral groove adjacent to the first main groove being formed with a protrusion that is a raised groove bottom, and
the first lateral groove having an edge formed with a first incision along a length direction of the first lateral groove at least in an area where the protrusion is formed.

2. The pneumatic tire according to claim 1, wherein the protrusion has a height corresponding to 40% to 70% of a depth at a deepest part of the first lateral groove.

3. The pneumatic tire according to claim 1, wherein the first incision narrows from a side of the first main groove toward a ground contact end in a plan view of the tread.

4. The pneumatic tire according to claim 1, wherein
the tread includes:
a second main groove that extends in the circumferential direction and is located on a vehicle inner side when the pneumatic tire is mounted on the vehicle; and
a second shoulder block that is defined by the second main groove and disposed on the vehicle inner side, and
the second shoulder block is formed with a second lateral groove that extends in a direction crossing the second main groove and terminates within the block.

5. The pneumatic tire according to claim 4, wherein
the tread further includes:
a third main groove that is formed between a tire equator and the first main groove and extends in a tire circumferential direction;
a fourth main groove that is formed between the tire equator and the second main groove and extends in the tire circumferential direction; and
three ribs defined by the first main groove, the second main groove, the third main groove, and the fourth main groove.

6. The pneumatic tire according to claim 1, wherein the protrusion is formed in an area in the first lateral groove, the area extending from the first main groove, and the area being formed within 30% of a length of the first lateral groove along a tire axial direction.

7. The pneumatic tire according to claim 4, wherein a width of a ground contact surface of the second shoulder block is smaller than a width of a ground contact surface of the first shoulder block.

8. The pneumatic tire according to claim 5, wherein
individual widths of the third main groove and the fourth main groove are larger than individual widths of the first main groove and the second main groove, and
a width of the first main groove is larger than a width of the second main groove.

9. The pneumatic tire according to claim 5, wherein
the ribs include a first rib, a second rib, and a third rib,
the first rib has a first sipe that is formed to extend from the third main groove and terminate within the rib,
the second rib has second sipes that are formed to extend from the first main groove and terminate within the rib, and
the third rib has third sipes that are formed to extend from the second main groove and terminate within the rib.

10. The pneumatic tire according to claim 9, wherein the first lateral groove and the second sipes are alternately disposed along the tire circumferential direction with the first main groove interposed therebetween.
